(19) United States
(12) Patent Application Publication
(10) Pub. No.: US 2005/0155278 A1
(43) Pub. Date: Jul. 21, 2005

(54) Fire ant eradication method

(76) Inventor: Hugh Miller Rawls, Marianne, FL (US)

Correspondence Address: Pennington, Moore, Wilkinson, Bell & Dunbar, P.A., Post Office Box 10095, Tallahassee, FL, 32302-2095, US

(21) Appl. No.: 10/761,024

(22) Filed: Jan. 20, 2004

(51) Int. Cl. A01M 17/00; A01M 11/00; A01M 7/00

(52) U.S. Cl. 43/132.1

(57) ABSTRACT

A method for eradicating fire ants by permeating the soil in a fire ant mound with a combination of very small particles, vegetable oil, and Pyrethrin. The particles tend to infiltrate and disable the joint structure of the ants, eventually killing them. One particularly effective composition includes diatomaceous clay—commonly known as fuller's earth.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the destruction of imported fire ants of the genus solenopsis invicta, and specifically to a method which destroys the ants by injecting a colloid of water and suspended small particles into the soil.

2. Description of the Related Art

The South American fire ant has been a problem in the United States since the early part of the twentieth century. It has been tremendously successful in expanding its habitat at the expense of other indigenous ants. The fire ant's success is largely due to the following documented characteristics: (1) Any disturbance of the fire ant mound will cause the colony to attack the intruder in mass; (2) Any disturbance sufficient to destroy the mound will cause the ants to rapidly transport the queen to safety through a series of underground tunnels extending outwards for as much as 75 feet; and (3) So long as the queen and a few thousand ants survive the attack, a new mound may rapidly be established.

Various methods have been employed to kill an ant colony. One known technique is to insert a probe into the mound and inject vaporized insecticides, as shown in the U.S. Pat. No. 4,756,118 to Evans (1988). Another method is to flood the mound with insecticides dissolved in water, as shown in U.S. Pat. No. 5,054,231 to Witherspoon (1991). Both these methods depend on the user manually thrusting the probe into the mound, which requires substantial strength and often limits the depth of penetration. Some ant colonies bury the queen three or more feet below ground level, meaning that the methods shown in the '118 and '231 patents may have difficulty destroying the queen before she can be removed.

Various prior art devices can be used to aid the insertion of a probe into the ground. My own prior U.S. Pat. No. 6,026,609 (2000) discloses the use of a hydraulic ram to insert a probe. U.S. Pat. No. 3,886,874 to Platz (1975) discloses the use of an impact hammer (often called a “jackhammer”) to ram a probe into the soil. The Platz device requires a high-pressure air line as its power source.

These prior art approaches have had limited success. Most authorities now agree that it is difficult to completely eradicate a population of fire ants. However, it is possible to significantly reduce the population and to thereby contain its spread.

### BRIEF SUMMARY OF THE INVENTION

The present invention comprises a method for eradicating fire ants by permeating the soil in a fire ant mound with a mixture of very small particles, vegetable oil and Pyrethrin. The particles tend to infiltrate and disable the joint structure of the ants, eventually killing them. One particularly effective composition is diatomaceous clay—commonly known as fuller's earth.

The delivery method incorporates a pump which pressurizes water and feeds it into a mixer. The mixer adds a continuous stream of Fuller's earth, which mixes with the water to form a colloid. The pressurized mixture is then fed through a flexible line to an injector assembly, including a probe on its lower extreme. The user thrusts the probe into an ant mound occupied by the fire ants. The colloid of water, fuller's earth, and other substances is then injected through a central passageway within the probe.

### BRIEF DESCRIPTION OF THE SEVERAL VIEWS OF THE DRAWINGS

FIG. 1 is an isometric view, showing the proposed invention.

FIG. 2 is an isometric view, showing the injector assembly.

FIG. 3 is an isometric view, showing the probe.

FIG. 4 is an isometric sectional view, showing the internal features of the probe.

FIG. 5 is an isometric view, showing a portable version of the present invention.

FIG. 6 is an isometric view with a cutaway, showing a multi-port injector

FIG. 7 is a section view, showing the multi-port injector in operation.

FIG. 8 is a perspective view, showing the multi-port injector mounted on a trailer.

REFERENCE NUMERALS IN THE DRAWINGS

| | | | |
|---|---|---|---|
| 10 | water tank | 12 | pump |
| 14 | hopper | 16 | mixer |
| 18 | outlet | 20 | injector assembly |
| 22 | feed line | 24 | pistol grip |
| 26 | side handle | 28 | trigger |
| 30 | hammer assembly | 32 | reciprocating shaft |
| 34 | probe | 36 | recessed annulus |
| 38 | venturi | 40 | injection manifold |
| 42 | hose reel | 48 | trailer |
| 50 | pump inlet | 52 | discharge line |
| 54 | multi-port injector | 56 | injection head |
| 58 | feed line | 60 | rod |
| 62 | cylinder | 64 | cylinder mount |
| 66 | distribution plate | 68 | mound cover |
| 70 | conduit | 72 | ant mound |
| 74 | orifice | | |

### DETAILED DESCRIPTION OF THE INVENTION

The present invention proposes controlling fire ants by injecting a variety of substances suspended in water into the ant mound. The substances will be described in detail after an explanation of the devices used to inject the substances.

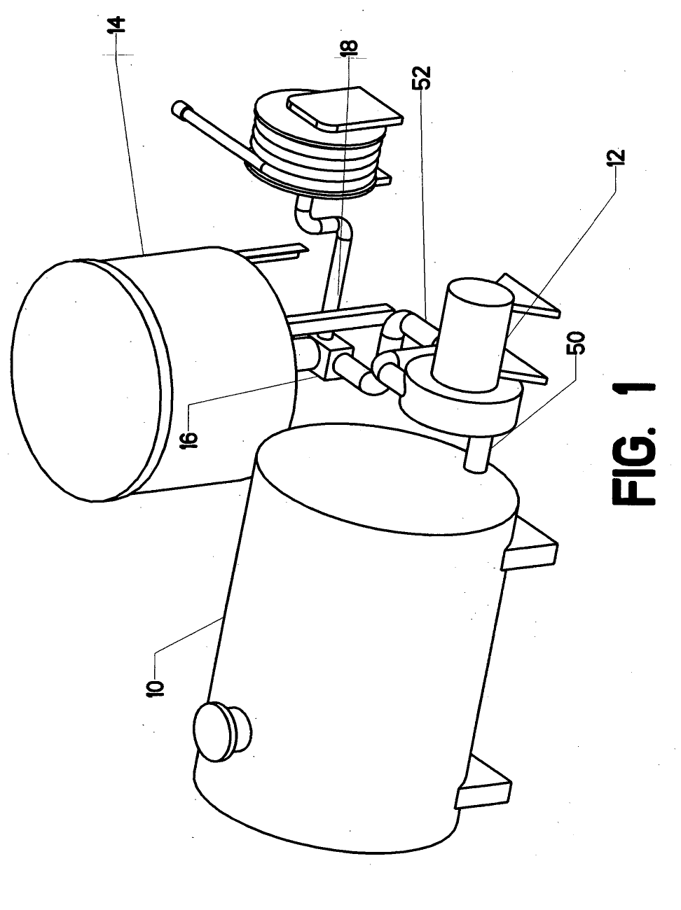

FIG. 1 shows the larger elements of a typical injection apparatus. Water tank 10 holds water to be fed into the device. This allows the invention to be portable for agricultural and other relatively remote applications. However, the use of a tank is not critical. If a different water source is available, it could be used as well.

Water is fed from water tank 10 to pump 12 through pump inlet 50. Pump 12 pressurizes the water, then feeds it to mixer 16 through discharge line 52. Hopper 14 feeds the substances to be injected (which may include liquids and solids) into mixer 16, where they are injected into the pressurized water to form a colloid. The colloid is then discharged through outlet 18.

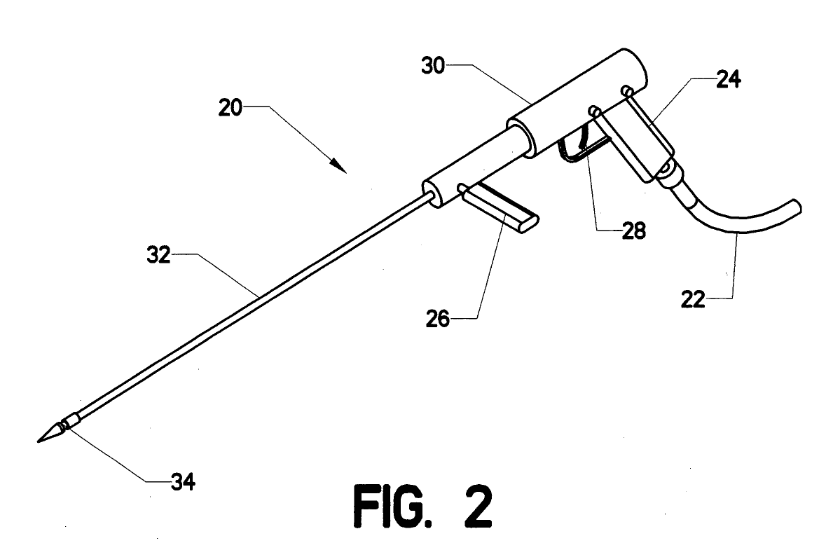

The colloid can be delivered to an ant mound using a variety of devices. FIG. 2 shows a device which can be carried by a person on foot—denoted as injector assembly 20. Feed line 22, which is typically ten feet or more in length, is connected to outlet 18. The pressurized colloid is thereby fed to injector assembly 20. A user grasps injector assembly 20 by pistol grip 24. Side handle 26 is preferably provided for the user's other hand, in order to aid stability. Both pistol grip 24 and side handle 26 are attached to hammer assembly 30.

Reciprocating shaft 32 extends downward to probe 34. In use, the user grasps pistol grip 24 and side handle 26, then thrusts probe 34 into the ground. The user then presses trigger 28. This action allows the flow of the pressurized colloid into hammer assembly 30, down through reciprocating shaft 32, and into probe 34. Probe 34 contains a plurality of venturi which allow the pressurized colloid to escape outward into the surrounding earth.

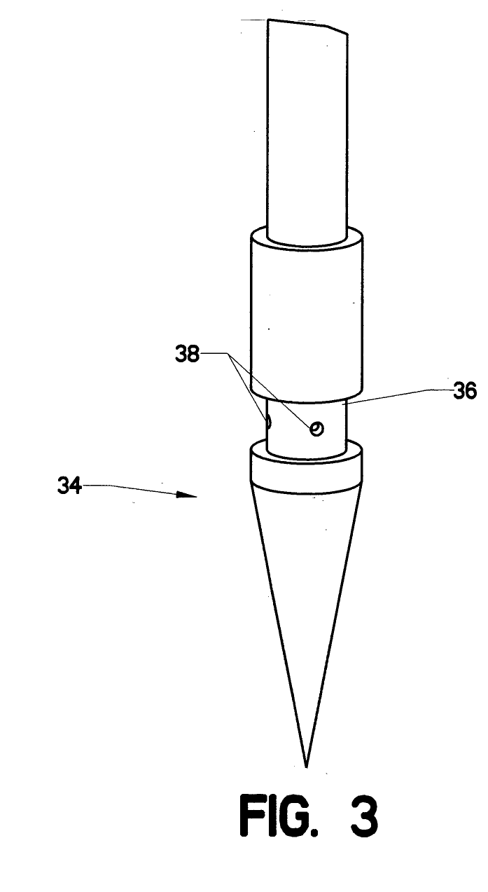

FIG. 3 shows a detail view of probe 34. The reader will observe its pointed lower tip, shaped to facilitate thrusting into the soil. The reader will also observe that its outer cylindrical surface contains recessed annulus 36. A plurality of venturi 38 are arrayed around recessed annulus 36. The recess tends to prevent soil from clogging venturi 38 when probe 34 is thrust into the ground.

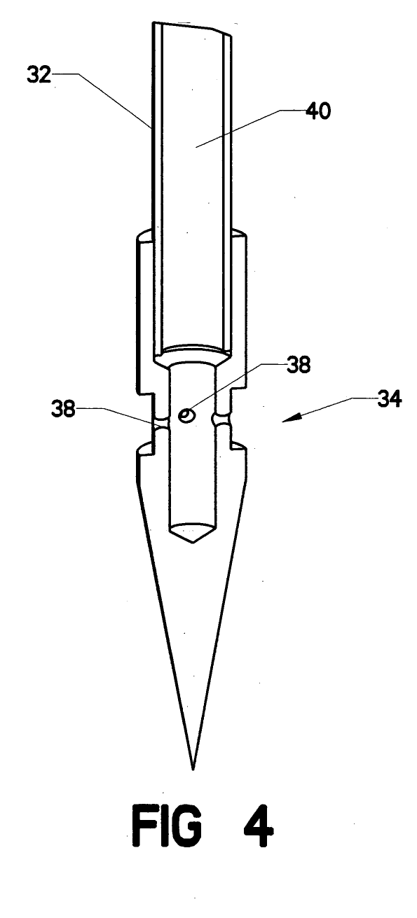

FIG. 4 shows a section view of probe 34. The reader will observe that reciprocating shaft 32 is hollow, forming injection manifold 40 down its center. The interior of probe 34 is likewise hollow, with injection manifold 40 continuing for some distance into its interior. This lower portion of injection manifold 40 opens into a plurality of venturi 38, which exit probe 34.

Thus, those skilled in the art will realize that when the pressurized colloid is introduced into injection manifold 40, it will flow down through reciprocating shaft 32, into probe 34, and out through the plurality of venturi 38. Those skilled in the art will also realize, however, that soil conditions may make the insertion of probe 34 difficult. This is particularly true in hot and dry conditions, where fire ants are common. An additional feature has been added to the invention to remedy this problem.

Returning now to FIG. 2, this additional feature will be explained. Hammer assembly 30 contains a flow control valve which is actuated by trigger 28. In normal operations, pump 12 runs continuously, maintaining the colloid in a pressurized state. Thus, feed line 22 remains pressurized. When the user depresses trigger 28, the colloid flows through the control valve in hammer assembly 30, and then down into injection manifold 40—which is fluidly connected with the control valve.

Hammer assembly 30 also incorporates a cyclic valve which the user can turn on or off as desired. If turned on, the cyclic valve produces a pulsed pressure input to reciprocating shaft 32. Reciprocating shaft 32 is attached to hammer assembly 30 in such a fashion as to be free to move in and out of the hammer assembly through a limited distance. Spring biasing means tend to pull the reciprocating shaft into the hammer assembly. The cyclic valve moves reciprocating shaft 32 out of the hammer assembly in a rapid, violent motion (with respect to hammer assembly 30). The return springs pull it back. In effect, this action makes injector assembly 20 into a light duty jackhammer. The cyclic valve is preferably slaved to the flow control valve, so that when the user depresses trigger 28, both the colloid flow and the jackhammer action are initiated. The jackhammer action significantly assists the insertion of probe 34 into the ground.

Since many soil conditions will not require the jackhammer action, it is preferable to have the option to turn off the cyclic valve. As both the flow control cyclic valve, and jackhammer action are well known in the prior art, they will not be described in greater detail.

From the preceding description, the reader will understand that the invention is capable of suspending liquids or solids in water to form a colloid. The invention is capable of then shooting this colloid into the ground under substantial pressure. This results in the dispersion of the fine particles in the ground.

If probe 34 is thrust into an ant mound and flow is then initiated, the colloid will be dispersed throughout the loosely packed soil within the mound. Using the jackhammer action, reciprocating shaft 32 can be thrust completely into the mound. It is therefore possible to thrust probe 34 three feet or more below ground level. This depth may be needed, depending upon the prevailing conditions. In cold weather, solenopsis ants may bury the queen to a depth of three feet or even more. Longer reciprocating shafts 32 can be employed if needed.

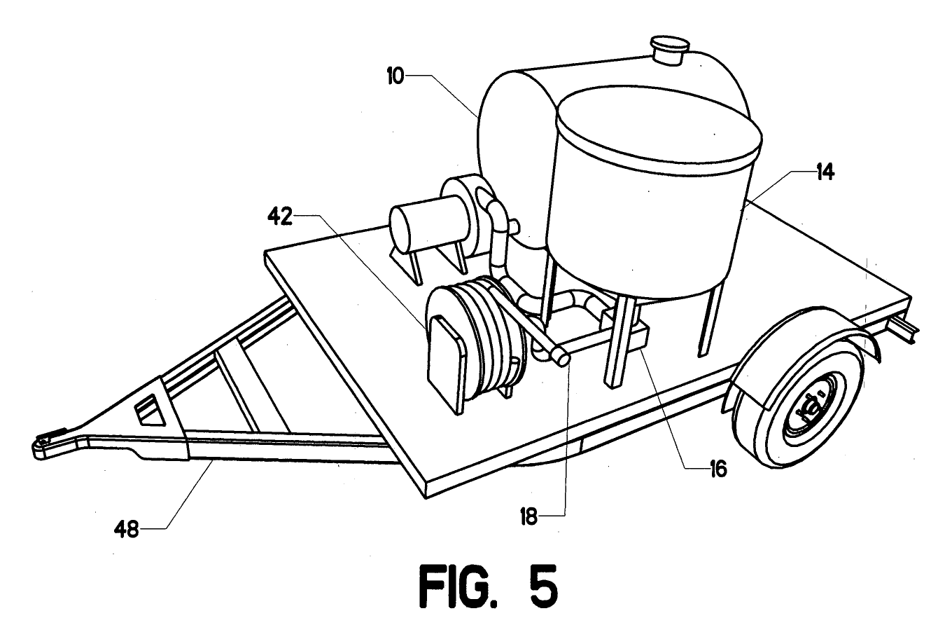

The components described for feeding the injection device have considerable weight and consideration should be given to making the device portable—since ant mounds are often widely dispersed. FIG. 5 shows the basic components mounted on trailer 48. Water tank 10 feeds into pump 12. Pump 12 feeds into mixer 16, which is situated directly beneath hopper 14. The user may open the top of hopper 14 to load the diatomaceous clay (typically supplied in bags). Hopper 14 may incorporate vibratory feeder and auger mechanisms, both of which are well known in the prior art. Whenever flow is initiated by the user, pressurized water flows through mixer 16. A stream of diatomaceous clay flows from hopper 14 into mixer 16, where it is mixed into the water by a turbulent swirling flow. The result is a pressurized colloid leaving mixer 16.

It is advantageous to provide the user with a length of hose to allow the user to treat several mounds in close proximity. Hose reel 42 is provided for this purpose. The pressurized colloid flows into the hose coiled on hose reel 42, and eventually out to outlet 18. Those skilled in the art will know that as the user tugs on outlet 18, additional hose will unwind from hose reel 42 (the reader will recall that outlet 18 is connected to feed line 22 on injector assembly 20).

Trailer 48 is fitted with a hitch so that it can be towed by a tractor, truck, or ATV. In practical application, the user tows trailer 48 to a position in the center of a number of ant mounts. The user then grasps injector assembly 20 and walks around to treat the different mounds. Hose reel 42 allows the user to extend the position of outlet 18. Hose reel 42 is preferably fitted with a retracting mechanism so that it respools unneeded hose.

During operation, there may be extended periods where the user does not initiate the flow of the colloid. This period of inactivity may cause unwanted wear on the pump (due to maintaining the pump at its shut-off head). It may also cause uneven mixing in mixer 16, since the mixing action typically depends on flow. To remedy this problem, a return line can be added. This return line would start downstream of the mixer and return to pump inlet 30. During the periods when trigger 28 is not depressed, this return line would be activated—producing continuous flow through mixer 16 and ensuring an even colloid.

Those skilled in the art will know that the position of mixer 16 within the fluid circuit is a question of engineering convenience. The colloid could be formed within water tank 10, or in pump inlet 50.

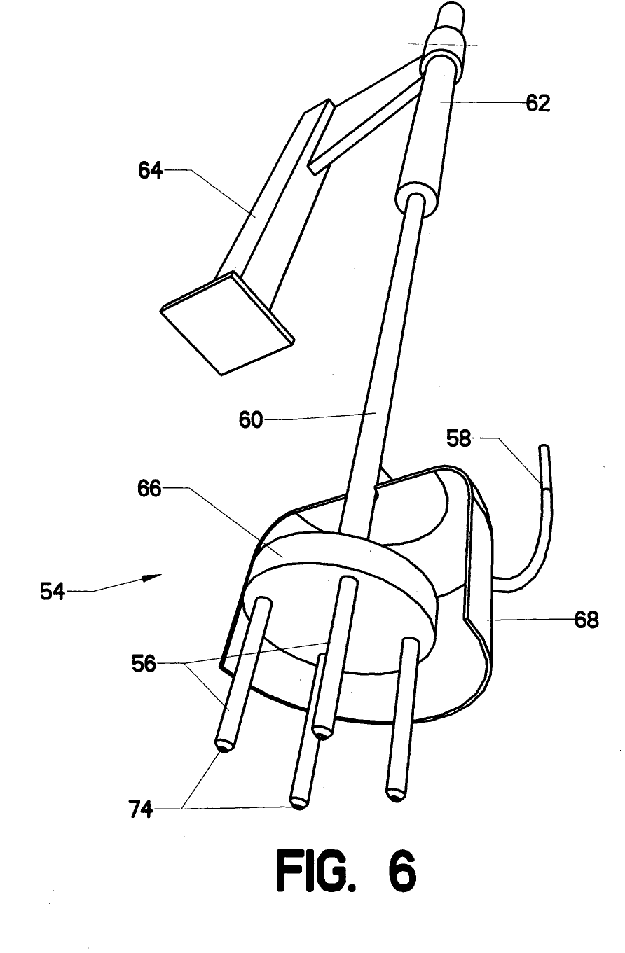

Other devices can be used to more rapidly infuse an ant mound with the solid or liquid to be injected. FIG. 6 shows one such device—multi-port injector 54. Cylinder 62 is attached via cylinder mount 64 to a trailer or other moving object (since multi-port injector 54 is typically too heavy to be easily carried). Rod 60 extends from the lower end of cylinder 62. Distribution plate 66 is mounted on the rod's lower extreme. It contains four injection heads 56, each of which includes a downward-pointing orifice 74.

Rod 60 extends and retracts from cylinder 62. The cylinder may be of the lift-only type. In such an embodiment, hydraulic pressure is used only to lift the rod and its attached hardware. The rod and attached hardware are allowed to drop under the force of gravity.

Feed line 58 attaches rod 60 to outlet 18. An internal conduit within the rod carries the pressurized liquid down to the distribution plate, where internal conduits carry the liquid out to the injection heads and out through the four orifices 74. Mound cover 68 mounts on rod 60 above distribution plate 66. It is free to slide up and down independently of the rod.

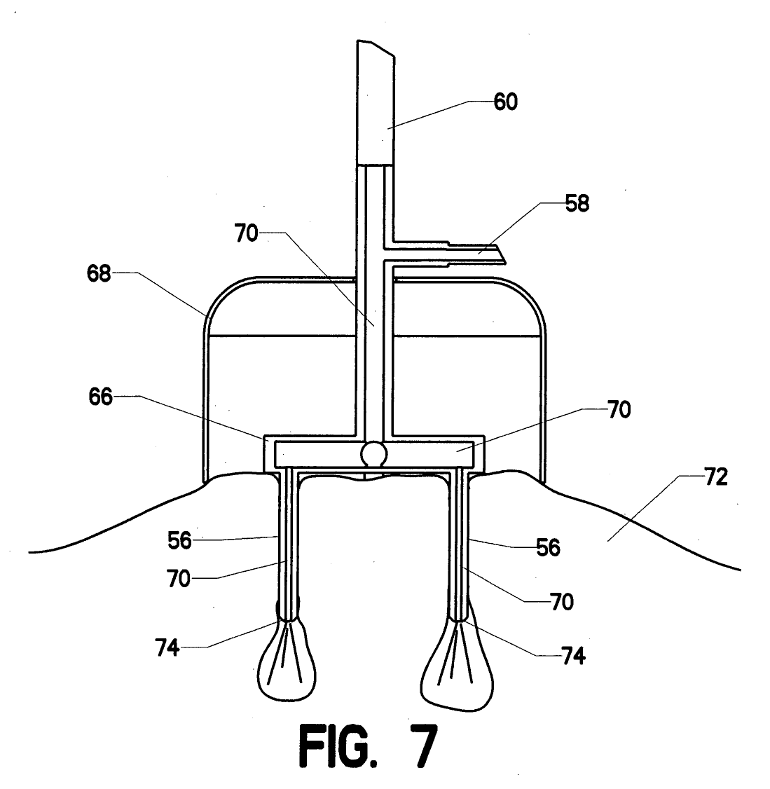

FIG. 7 shows the multi-port injector in use. It has been positioned over ant mound 72. Cylinder 62 is then released to allow distribution plate 66 to fall (Or, if downward hydraulic pressure is employed, the hydraulic pressure forces the downward extension of the rod). At the same time the downward motion of the rod is initiated, fluid flow is initiated through the device. It flows into conduit 70, which passes down through the center of the rod, out through cavities within the distribution plate, down through the injection heads, and out in pressurized streams. These pressurized streams blast holes beneath the injection heads, which allow the distribution plate to sink down onto the mound. Meanwhile, mound cover 68 has settled over the mound, thereby sealing the top of the mound so that the fluid (and contained solids) being injected are contained.

Once an injection cycle is completed, cylinder 62 is activated to lift the distribution plate and associated hardware upwards and clear of the mound. The distribution plate will catch and lift the mound cover, lifting it clear as well.

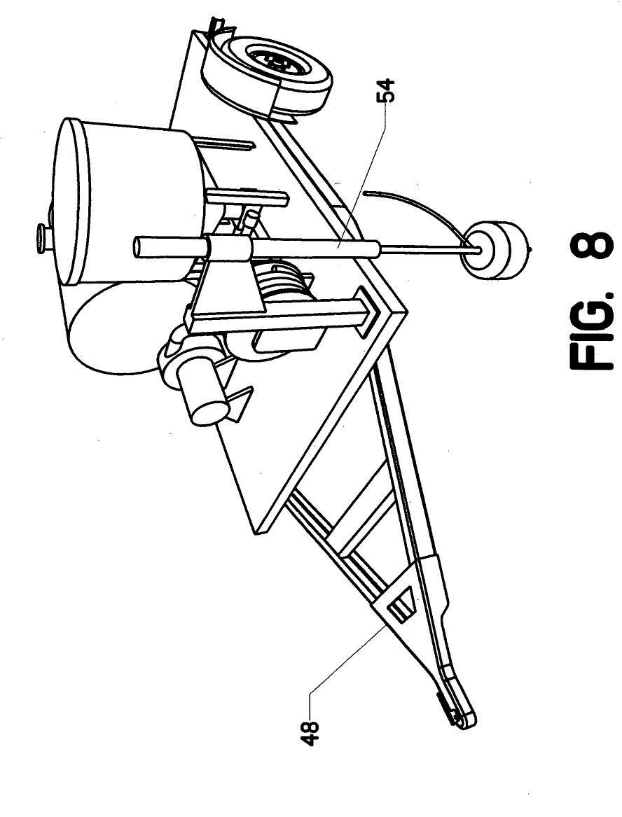

FIG. 8 shows a typical mounting of multi-port injector 54 on a trailer 48. The cylinder mount is attached to the deck of the trailer so that the cylinder is positioned to the side. An adjustable mounting, such as a swinging boom, can also be provided.

These devices thus disclosed can be used to inject a mixture of water and solids or liquids into an ant mound. The present invention contemplates the use of several different materials to be injected.

A first approach is to suspend very small particles in the water to be injected. Once the mixture is injected, the water tends to evaporate and leave the fine particles behind. These particles are of a very small size, much smaller than typical soil particles. They tend to cling to the ants as the ants move through the interior of the mound. The clinging results from simple mechanical interaction, as well as static electricity. Those skilled in the art will know that small particles tend to greatly impede the motion of ants and other insects. Insects have an exoskeletal structure. Their leg joints often expose a gap between adjoining exoskeletal segments. Small particles tend to fill the gaps, greatly impairing the motion of the insect and eventually killing it.

Although many finely particulated substances could be employed in the present invention, diatomaceous clay has been found to be particularly effective (also known as “fuller's earth”). This substance is a naturally occurring soil product. It is typically refined by sifting to produce a very uniform particle size. It produces an excellent colloid—with the particles remaining in suspension for two hours or more. It is also completely inert—meaning that it has no adverse environmental impact. The present invention simply injects water and a natural soil product into the ground.

The diatomaceous earth tends to interfere with the insect's joint operation. It also absorbs a great deal of water, tending to dehydrate any insect coming into contact with it. This dehydration can substantially impair or kill the insect.

Borax particles can also serve the dual purposes of interfering with joint operation and dehydrating the insect. Anyhdrous borax is particularly effective for the latter objective, since it readily absorbs moisture.

Other small particles can be effective in disabling the ants. Finely ground glass particles can work. These remain suspended in water for a sufficient time and are inert once injected into the ground. Finely ground iron or steel “filings” are also effective (other metal filings can be used as well). These have the added property of rapidly corroding into iron oxide dust. They are non-toxic and can even provide a mildly beneficial effect to mineral-deficient soil.

The operation of these fine particles can be augmented by the addition of insecticides. A small amount of Pyrethrin (a natural flower extract with insect repelling and destroying properties) can be added to the water-based mixture.

Finally, certain vegetable oils can be added to the mixture. These oils have a repelling effect since they tend to form sticky deposits within the mound. Such oils are, of course, reasonably safe within the soil. Suitable vegetable oils include sunflower oil soybean oil, corn oil, olive oil, peanut oil, safflower oil, cottonseed oil, and palm oil

Examples of the compositions to be used in treating the ant mounds follow:

### EXAMPLE ONE

A finely ground particle mixture was created using the following ingredients, stated in terms of the mass percentage of each ingredient:

| | |
|---|---|
| Diatomaceous earth | 25%-75% |
| Anhydrous borax | 25%-75% |

This particle mixture was thoroughly mixed into water and then injected into the ant mound under pressure.

### EXAMPLE TWO

A finely ground particle mixture was created using the following ingredients, stated in terms of the mass percentage of each ingredient:

| | |
|---|---|
| Diatomaceous earth | 25%-75% |
| Ground Glass | 25%-75% |

This particle mixture was thoroughly mixed into water and then injected into the ant mound under pressure.

### EXAMPLE THREE

A finely ground particle mixture was created using the following ingredients, stated in terms of the mass percentage of each ingredient:

| | |
|---|---|
| Diatomaceous earth | 25%-75% |
| Fine metal filings | 25%-75% |

This particle mixture was thoroughly mixed into water and then injected into the ant mound under pressure.

### EXAMPLE FOUR

A finely ground particle mixture was created using the following ingredients, stated in terms of the mass percentage of each ingredient:

| | |
|---|---|
| Diatomaceous earth | 15%-50% |
| Anhydrous borax | 15%-50% |
| Ground Glass | 15%-50% |

This particle mixture was thoroughly mixed into water and then injected into the ant mound under pressure.

### EXAMPLE FIVE

A finely ground particle mixture was created using the following ingredients, stated in terms of the mass percentage of each ingredient:

| | |
|---|---|
| Diatomaceous earth | 15%-50% |
| Anhydrous borax | 15%-50% |
| Metal filings | 15%-50% |

This particle mixture was thoroughly mixed into water and then injected into the ant mound under pressure.

### EXAMPLE SIX

A finely ground particle mixture was created using the following ingredients, stated in terms of the mass percentage of each ingredient:

| | |
|---|---|
| Diatomaceous earth | 15%-50% |
| Anhydrous borax | 15%-50% |
| Ground glass | 15%-50% |
| Metal filings | 15%-50% |

This particle mixture was thoroughly mixed into water and then injected into the ant mound under pressure.

### EXAMPLE SEVEN

A finely ground particle mixture was created using the following ingredients, stated in terms of the mass percentage of each ingredient:

| | |
|---|---|
| Diatomaceous earth | 15%-50% |
| Anhydrous borax | 15%-50% |
| Ground glass | 15%-50% |
| Metal filings | 15%-50% |
| Vegetable oil | 15%-50% |

The solid portion of the mixture was thoroughly mixed. The solid mixture and the vegetable oil were then thoroughly mixed into water and then injected into the ant mound under pressure.

A quantity of Pyrethrin between about 0.2% and 5% per unit mass can be added to any of the prior examples given. All of the examples are diluted considerably when mixed with the water. The solid/liquid additives typically comrpise between about 0.5% and about 10% of the total mass of the additive/water mixture.

Although the preceding description contains significant detail, it should not be construed as limiting the scope of the invention but rather as providing illustrations of the preferred embodiment of the invention. As an example, other pressurizing means could be substituted for the pump employed in the preferred embodiment. Pressurized air could be fed into water tank 10 to pressurize the water lines without the need for a pump. Thus, the scope of the invention should be fixed by the following claims, rather than by the examples given.

1. A method for eradicating fire ants and other insects dwelling in the ground, comprising:
a. providing a carrier fluid;
b. providing a first mixture of solid diatomaceous earth and anhydrous borax;
c. mixing said first mixture into said carrier fluid to form a second mixture;
d. providing an injector, including at least one probe with at least one orifice;
e. thrusting said at least one probe into said ground; and
f. injecting said second mixture through said at least one orifice into said ground.

2. A method as recited in claim 1, wherein said first mixture further comprises ground glass particles.

3. A method as recited in claim 1, wherein said first mixture further comprises metal filings.

4. A method as recited in claim 1, wherein said first mixture further comprises vegetable oil.

5. A method as recited in claim 1, wherein said first mixture further comprises Pyrethrin.

6. A method as recited in claim 2, wherein said first mixture further comprises metal filings.

7. A method as recited in claim 4, wherein said first mixture further comprises metal filings.

8. A method as recited in claim 5, wherein said first mixture further comprises metal filings.

9. A method as recited in claim 3, wherein said first mixture further comprises vegetable oil.

10. A method as recited in claim 5, wherein said first mixture further comprises vegetable oil.

11. A method as recited in claim 6, wherein said first mixture further comprises vegetable oil.

12. A method as recited in claim 2, wherein said first mixture further comprises Pyrethrin.

13. A method as recited in claim 3, wherein said first mixture further comprises Pyrethrin.

14. A method as recited in claim 4, wherein said first mixture further comprises Pyrethrin.

15. A method as recited in claim 6, wherein said first mixture further comprises Pyrethrin.

16. A method as recited in claim 7, wherein said first mixture further comprises Pyrethrin.

17. A method as recited in claim 9, wherein said first mixture further comprises Pyrethrin.

18. A method as recited in claim 11, wherein said first mixture further comprises Pyrethrin.
